(19) United States
(12) Patent Application Publication
(10) Pub. No.: US 2022/0067275 A1
(43) Pub. Date: Mar. 3, 2022

(54) SYSTEMS AND METHODS FOR DATA EXTRACTION FROM UNSTRUCTURED DOCUMENTS

(71) Applicant: IRON MOUNTAIN INCORPORATED, Boston, MA (US)

(72) Inventors: Zhihong Zeng, Acton, MA (US); Samriddhi Shakya, Washington DC, DC (US); Anwar Chaudhry, Mississauga (CA); Rajesh Chandrasekhar, Franklin, TN (US); Harvarinder Singh, Toronto (CA); Henry Ng, Markham (CA)

(21) Appl. No.: 17/008,114

(22) Filed: Aug. 31, 2020

(51) Int. Cl. G06F 40/205; G06F 40/177; G06K 9/00

(52) U.S. Cl. CPC G06F 40/205; G06K 9/00442; G06F 40/177

(57) ABSTRACT

A computer-implemented method includes accessing, by a processor, an unstructured document. The method also includes performing, by the processor, box detection on the unstructured document to generate a box graph of the unstructured document. Further, the method includes integrating, by the processor, identified text of the unstructured document with the box graph of the unstructured document to build a text graph. Furthermore, the method includes generating, by the processor, a structured text representation of the unstructured document using the text graph.

### TECHNICAL FIELD

The field of the present disclosure relates to unstructured document processing. More specifically, the present disclosure relates to techniques for identifying tables in unstructured documents and extracting data from the tables.

### BACKGROUND

Tables within documents play an important role for the presentation of data in the documents. For example, data may be collected and presented in tables within legal documents, loan documents, medical record documents, energy usage record documents, research publication documents, and many other types of documents designed to provide a user with a concise description of data. Such data may be valuable for digital document data mining.

Automated document data mining processes may be incapable of extracting data from a table with sufficient context to be useful. Because tables are often structured in unique ways, the contextual information presented by a table in the document may be lost during the data extraction process. For example, a number displayed in a table may be extracted as a standalone value without context, or the number may be improperly assigned unrelated context.

### SUMMARY

The terms “disclosure,” “the disclosure,” “this disclosure” and “the present disclosure” used in this patent are intended to refer broadly to all of the subject matter of this application and the claims below. Statements containing these terms should be understood not to limit the subject matter described herein or to limit the meaning or scope of the claims below. This summary is a high-level overview of various aspects of the subject matter of the present disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain aspects of the present disclosure, a computer-implemented method includes accessing, by a processor, an unstructured document. The method also includes performing, by the processor, box detection on the unstructured document to generate a box graph of the unstructured document. Further, the method includes integrating, by the processor, identified text of the unstructured document with the box graph of the unstructured document to build a text graph. Furthermore, the method includes generating, by the processor, a structured text representation of the unstructured document using the text graph.

An additional example includes a computing system including one or more processors and one or more memory devices. The memory devices include instructions that are executable by the one or more processors for causing the one or more processors to access an unstructured document and to perform character recognition on text of the unstructured document to identify text within the unstructured document. Additionally, the instructions cause the one or more processors to perform box detection on the unstructured document to generate a box graph of the unstructured document. Further, the instructions cause the one or more processors to integrate the identified text of the unstructured document with the box graph of the unstructured document to build a text graph. Furthermore, the instructions cause the one or more processors to generate a structured text representation of the unstructured document using the text graph.

An additional example includes a non-transitory computer-readable medium including computer-executable instructions to cause a computer to perform operations. The operations include accessing, by a processor, an unstructured document. Additionally, the operations include performing, by the processor, character recognition on text of the unstructured document to identify text within the unstructured document. The operations also include performing, by the processor, box detection on the unstructured document to generate a box graph of the unstructured document. Further, the operations include integrating, by the processor, the identified text of the unstructured document with the box graph of the unstructured document to build a text graph. Furthermore, the operations include generating, by the processor, a structured text representation of the unstructured document using the text graph.

### BRIEF DESCRIPTION

The accompanying drawings, which are incorporated into and constitute a part of this specification, illustrate one or more certain examples and, together with the description of the example, serve to explain the principles and implementations of the certain examples.

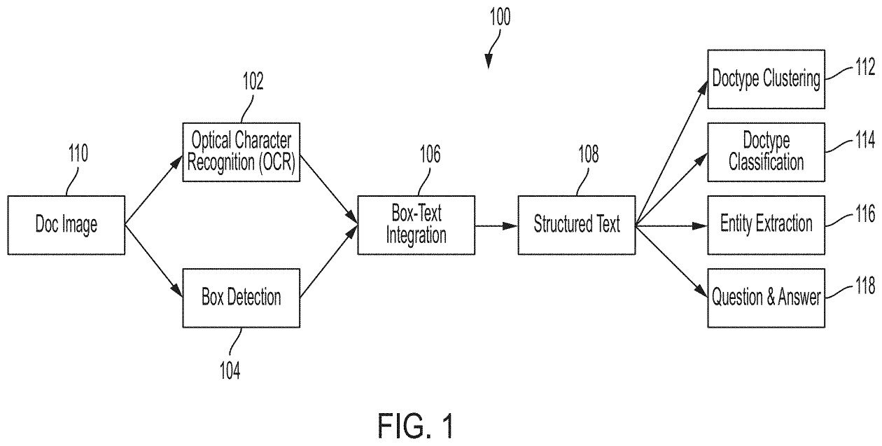

FIG. 1 is a block diagram of a document extraction system, according to certain aspects of the present disclosure.

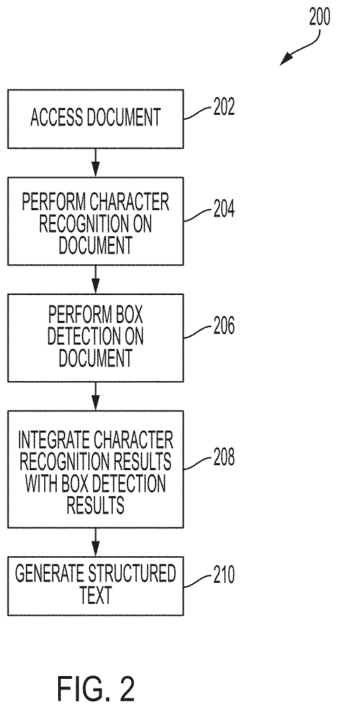

FIG. 2 is a flowchart of a process for extracting structured text from a document using the document extraction system of FIG. 1, according to certain aspects of the present disclosure.

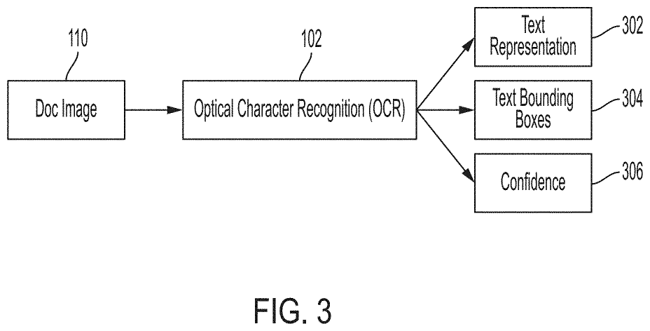

FIG. 3 is a block diagram of an optical character recognition module, according to certain aspects of the present disclosure.

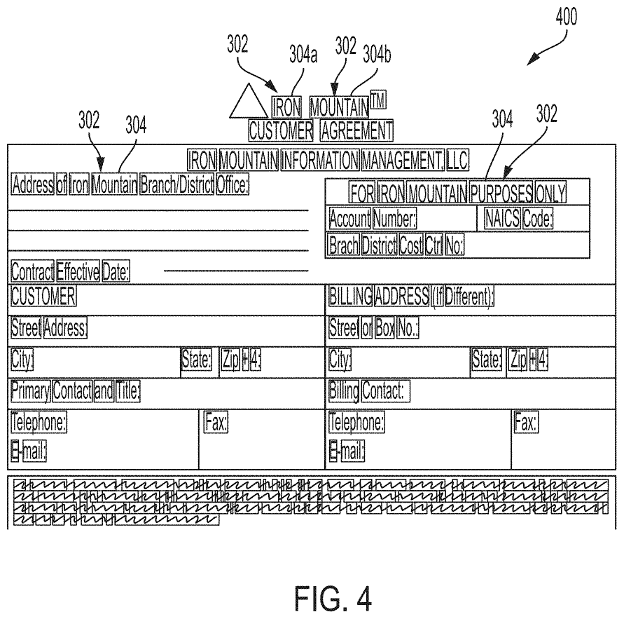

FIG. 4 is an example of an output of the optical character recognition module of FIG. 3, according to certain aspects of the present disclosure.

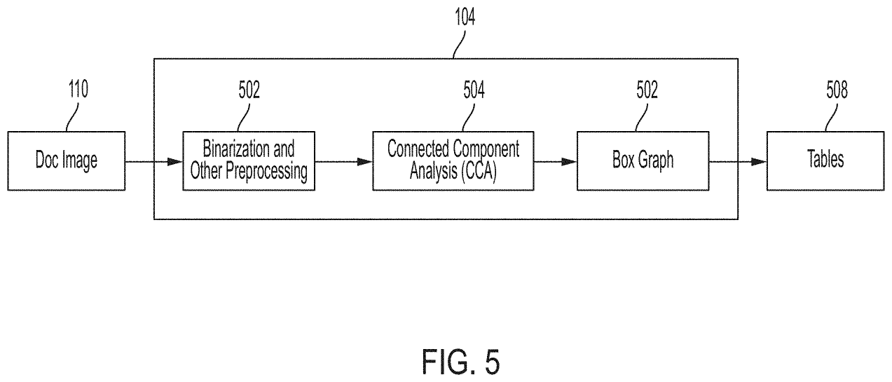

FIG. 5 is an example of a box detection module, according to certain aspects of the present disclosure.

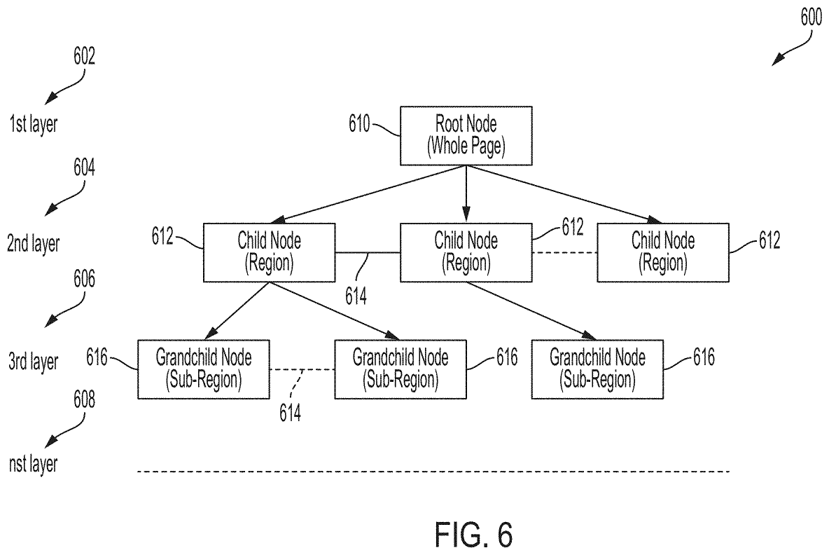

FIG. 6 is an example of a box graph representation of a document, according to certain aspects of the present disclosure.

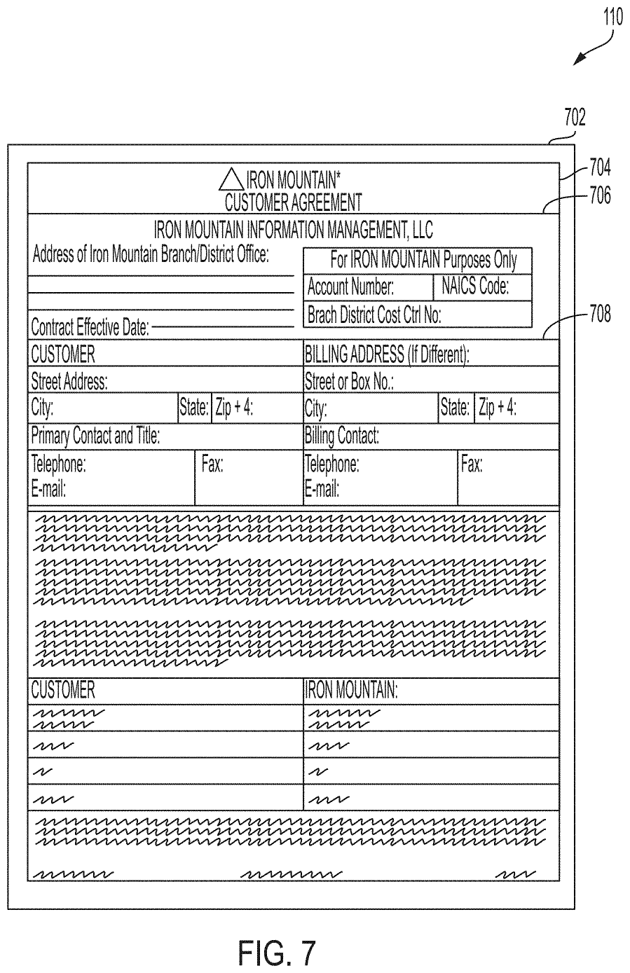

FIG. 7 is an example of detected boxes of an unstructured document generated by the box detection module of FIG. 5, according to certain aspects of the present disclosure.

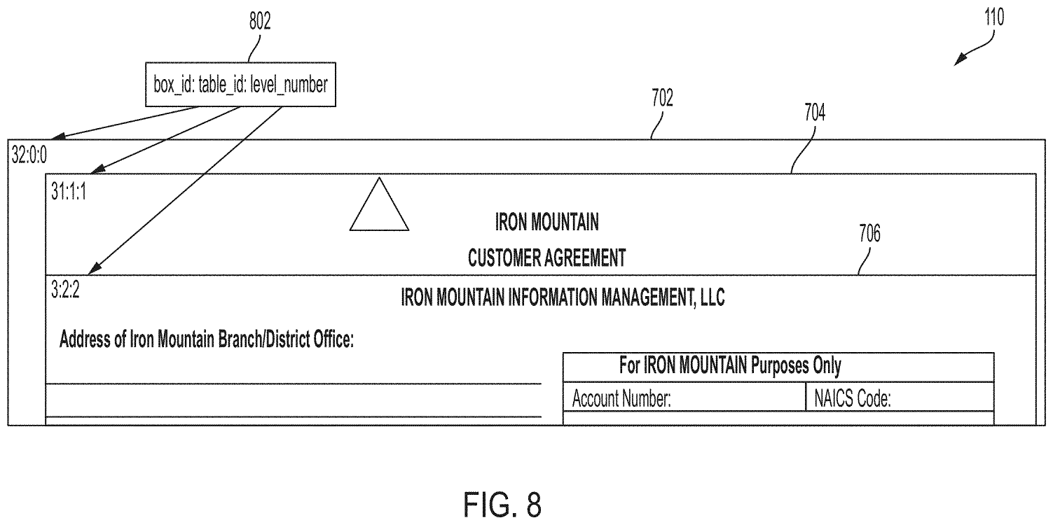

FIG. 8 is an example of a portion of the detected boxes of the unstructured document of FIG. 7, according to certain aspects of the present disclosure.

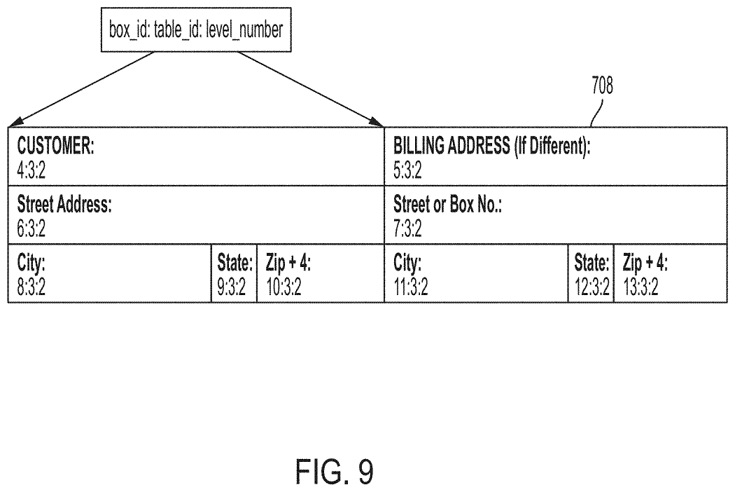

FIG. 9 is another example of a portion of the detected boxes of the unstructured document of FIG. 7, according to certain aspects of the present disclosure.

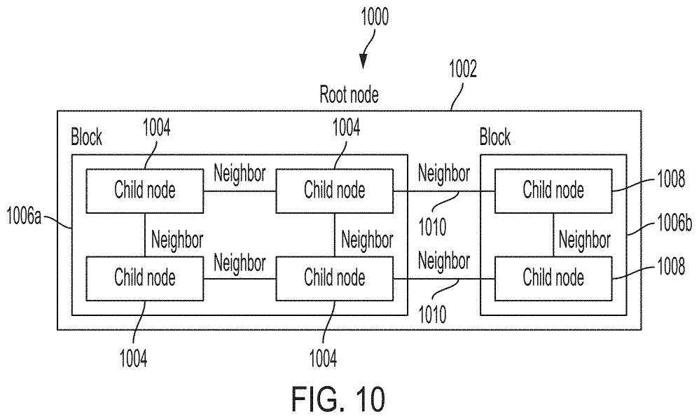

FIG. 10 is an example of a text graph representation of information extracted from an unstructured document, according to certain aspects of the present disclosure.

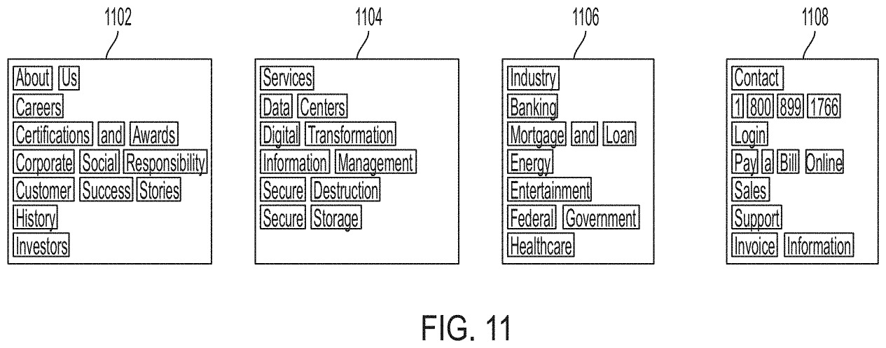

FIG. 11 is an example of a set of text blocks of the unstructured document, according to certain aspects of the present disclosure.

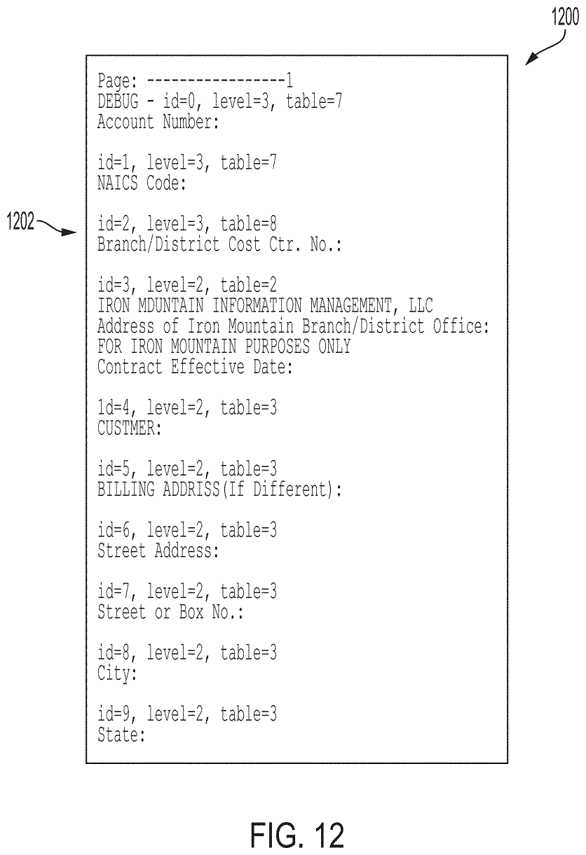

FIG. 12 is an example of a structured text representation of the unstructured document, according to certain aspects of the present disclosure.

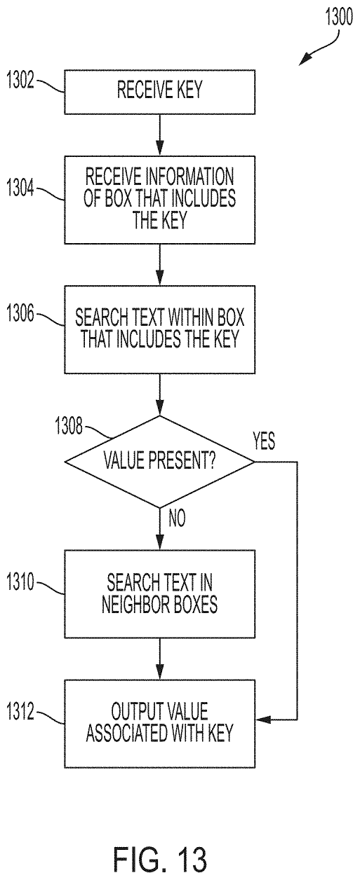

FIG. 13 is a flowchart of a process for performing an entity extraction process from a structured text representation of an unstructured document, according to certain aspects of the present disclosure.

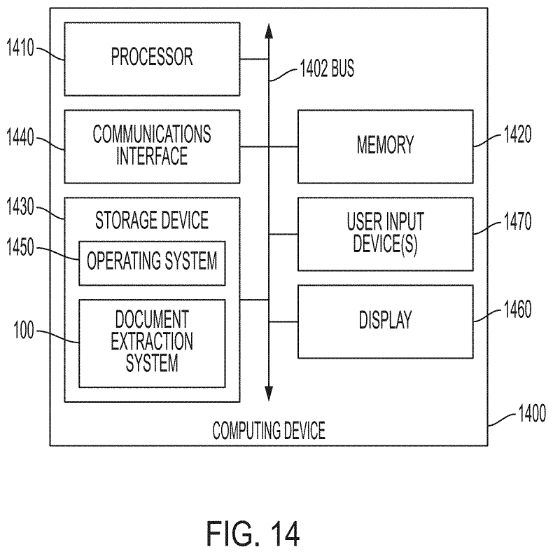

FIG. 14 is an example computing device suitable for implementing aspects of the techniques and technologies presented herein.

### DETAILED DESCRIPTION

The subject matter of embodiments of the present disclosure is described here with specificity to meet statutory requirements, but this description is not necessarily intended to limit the scope of the claims. The claimed subject matter may be implemented in other ways, may include different elements or steps, and may be used in conjunction with other existing or future technologies. This description should not be interpreted as implying any particular order or arrangement among or between various steps or elements except when the order of individual steps or arrangement of elements is explicitly described.

Certain aspects and examples of the disclosure relate to techniques for extracting data from unstructured documents. A computing platform may access one or more unstructured documents and perform processing operations on the documents. In some examples, the processing can include optical character recognition, box detection, box-text integration, structured text generation, or any combination thereof.

Upon processing the unstructured documents to generate a structured text representation, the computing platform may perform document type clustering, document type classification, entity extraction, or question and answer operations on content of the unstructured document using the structured text. For example, the structured text representation of the unstructured documents may provide context to the text content within the unstructured document. In this manner, data from tables that include valuable information may be extracted in a manner that the data includes context provided by the location of the data within a table. This contextual data may be leveraged by the operations that are performed by the computing platform to enhance the results of the operations, as discussed in detail below. Additional details regarding these and other aspects of the techniques presented herein will be provided below with regard to FIGS. 1-14.

By utilizing the techniques presented herein, data can be efficiently and contextually extracted from unstructured documents. Specifically, by integrating text recognition with box detection, a set of structured text representing the unstructured document can be generated.

FIG. 1 shows a block diagram of a document extraction system 100, according to certain aspects of the present disclosure. As shown in FIG. 1, the document extraction system 100 includes an optical character recognition module 102, a box detection module 104, and a box-text integration module 106 for generating a structured text representation 108 from an unstructured document 110, such as an image of a document. For example, the optical character recognition module 102 may identify characters in the unstructured document 110. In other words, the unstructured document 110 is converted by the optical character recognition module 102 into machine-encoded text representations of the unstructured document 110. In some examples, a structured document provided to or otherwise accessed by the document extraction system 100 may already be in a machine-encoded state. Accordingly, the document extraction process may proceed without the optical character recognition operation of the optical character recognition module 102 on such a document. Other text recognition operations may also be used on the documents in place of the optical character recognition operation. For example, optical word recognition, intelligent character recognition, intelligent word recognition, or any other text recognition operations may be used in place of the optical character recognition operation.

The unstructured document 110 may also be processed by the box detection module 104. In an example, the box detection module 104 applies a connected component analysis algorithm to the unstructured document. The connected component algorithm may detect connected regions in the unstructured document, such as boxes in a table. By identifying and labeling the boxes, the connected component analysis algorithm divides the unstructured document 110 into multiple regions. A box graph may be built by the box detection module 104 based on locations of the identified boxes, box-box overlapping, and relative distances between boxes. The box graph may provide an overall structure to the regions identified by the connected component algorithm.

The machine-encoded text and the box graph of the unstructured document 110 is provided to the box-text integration module 106. The box-text integration module 106 associates the boxes identified by the box detection module 104 with the text identified by the optical character recognition module 102. For example, locations within the unstructured document 110 of both the identified boxes and the machine-encoded text is known. Based on the known locations, the machine-encoded text may be associated with the boxes. For example, the box positions may be aligned with text vertices to determine which box with which to align the text. In some examples, a text graph is generated within each identified box to group the machine-encoded text within the identified box.

Upon integrating the machine-encoded text with the boxes from the unstructured document 110, a structured text representation 108 of the unstructured document 110 may be generated. The structured text representation 108 may be a high level programming language that is block structured. For example, the block structure of the structured text representation 108 may provide portions the machine-encoded text from the unstructured document 110 with context associated with other portions of the machine-encoded text. For example, the structured text representation 108 may provide an indication that certain portions of the text belong within a same table of the unstructured document 110.

The context associated with the machine-encoded text and provided by the structured text representation 108 may be used for natural language processing tasks. The natural language processing tasks can include document type clustering 112, document type classification 114, entity extraction 116, and question and answer processes 118. In an example, the document type clustering 112 may involve clustering the unstructured document 110 into one or more clusters of similar types of documents (e.g., clustering together bank statements) based on the structured text representation 108 of the unstructured document 110. The document type classification 114 may involve identifying a type of document (e.g., a mortgage application) of the unstructured document 110 based on the structured text representation 108. The entity extraction 116 may involve a key-value pattern. For example, a user may enter a customer name as a key into the entity extraction 116, and the entity extraction 116 may identify a value associated with the customer name form the structured text representation 108 of the unstructured document 110. The question and answer processes 118 may involve a user asking a question, and the question and answer processes 118 returning a result of the answer from the structured text representation 108 of the unstructured document 110. For example, a question “who is the customer identified in this document?” may return an answer indicated the name of a customer associated with the document. Other natural language processing tasks may also be performed using the structured text representation 108.

In some examples, the natural language processing tasks may be performed using artificial intelligence or machine learning. For example, the document type clustering 112, the document type classification 114, the entity extraction 116, and the question and answer processes 118 may each involve providing the structured text 108 to a trained machine-learning algorithm to generate a relevant output to the identified task. Additionally, document comprehension may involve providing the structured text 108 to a trained machine-learning algorithm to generate a relevant output. In an example, the trained machine-learning algorithm may be trained on a corpus of additional structured text representations of other unstructured documents to identify particular features of the unstructured documents relevant to the identified tasks.

In additional examples, the document type clustering 112, the document type classification 114, the entity extraction 116, and the question and answer processes 118 may all be performed as microservices of a remote or cloud computing system. Alternatively, the document type clustering 112, the document type classification 114, the entity extraction 116, and question and answer processes 118 may be performed locally as modules running on a computing platform associated with the document extraction system 100.

FIG. 2 is a flowchart of a process 200 for extracting the structured text 108 from the unstructured document 110 using the document extraction system 100, according to certain aspects of the present disclosure. At block 202, the process 200 involves accessing the unstructured documents 110. In an example, the unstructured documents 110 is stored in a manner that enables access to the unstructured document 110 by the document extraction system 100. The unstructured document 110 may be stored locally with the document extraction system 100, or the document extraction system 100 may access the unstructured document 110 from a remote storage system.

At block 204, the process 200 involves performing character recognition on the unstructured document 110. For example, the optical character recognition module 102 may identify characters in the unstructured document 110 using an optical character recognition technique. In other words, the optical character recognition module 102 converts the unstructured document 110 into a machine-encoded text representation of the unstructured document 110.

At block 206, the process 200 involves performing box detection on the unstructured document 110. For example, a connected component analysis algorithm may applied to the unstructured document 110. The connected component analysis algorithm may detect connected regions in the unstructured document, such as boxes in a table. By identifying and labeling the boxes, the connected component analysis algorithm divides the unstructured document 110 into multiple regions.

At block 208, the process 200 involves integrating the character recognition results of block 204 with the box detection results of block 206. For example, the boxes identified at block 206 are associated with the machine-encoded text representations identified at block 204. Locations within the unstructured document 110 of both the identified boxes and the machine-encoded text are known. Based on the known locations, the machine-encoded text may be associated with the applicable boxes. The box positions may be aligned with text vertices to determine the text that should be associated with each box.

At block 210, the process 200 involves generating the structured text representation 108. In an example, the structured text representation 108 includes an indication of a particular set of text and a location of that text within the unstructured text document 110. For example, the structured text representation 108 may include a box identification number, a table identification number, and a level number associated with a selection of the machine-encoded text generated from the unstructured text document 110. The structured text representation 108 may be used in various natural language processing tasks.

FIG. 3 is a block diagram of the optical character recognition module 102, according to certain aspects of the present disclosure. As discussed above, the optical character recognition module 102 may receive the unstructured document 110 and generate a machine-encoded text representation 302 of the unstructured document 110. Additionally, the optical character recognition module 102 may generate text bounding boxes 304 and a confidence score 306.

The text bounding boxes 304 may be representations of boxes that surround each word within the unstructured document 110. For example, each word of the unstructured document 110 may include a text bounding box. In some examples, distances between the text bounding boxes may be used to determine if neighboring text should be included within an individual text region. For example, bounding boxes that are located near one another may be combined to form a text region. The text region may represent a more complete thought than just the individual word within the bounding box. In one or more examples, the bounding boxes 304 may be used to identify a location within the unstructured document 110 of portions of text from the text representation 302 generated by the optical character recognition module 102.

The confidence score 306 may represent a quality of the text representation 302 extracted from the unstructured document 110. For example, the confidence score 306 may indicate confidence that an identified character or a group of characters is accurate. In an example, the confidence score 306 may be generated based on symbol signals, word patterns, and other semantic contexts. The confidence score 306 may be provided as a percent likelihood that the identified character or group of characters were accurately recognized by the optical character recognition module 102.

In an example, the confidence score 306 may be a field-level confidence score. The field-level confidence score may indicate the accuracy of a group of characters within an individual text bounding box 304. Such a confidence score may provide a percent likelihood that the characters in the text bounding box 304 are accurate. The field-level confidence score can be compared with a threshold score to separate usable data from unusable data that is extracted from the unstructured document 110. The threshold score may be set to 90% to ensure that the data represented in the unstructured document 110 is of suitable quality for further processing by the document extraction system 100. Other higher or lower threshold scores may also be used. In some examples, the confidence score 306 may be used with a natural language processing operation to contribute to a confidence score of, for example, an extracted entity.

FIG. 4 is an example of an output 400 of the optical character recognition module 102, according to certain aspects of the present disclosure. The output 400 can include the text representations 302 from the unstructured document 110. Additionally, the output 400 can include the text bounding boxes 304 surrounding each of the words of the text representations 302. In some examples, a distance between the text bounding boxes 304 may create text regions. For example, a smaller space between the bounding boxes 304 may indicate that neighboring bounding boxes 304 should be in the same text region. The text regions may express an entire thought such as a sentence or statement. As shown, the text bounding boxes 304a and 304b may each be part of the same text region, “Iron Mountain,” within the unstructured document 110.

FIG. 5 is an example of the box detection module 104, according to certain aspects of the present disclosure. In an example, the box detection module 104 includes a binarization module 502, a connected component analysis (CCA) module 504, and a box graph module 506. The box detection module 104 receives the unstructured document 110 and outputs an indication of tables 508 within the unstructured document 110.

At the binarization module 502, the box detection module 104 may ensure that the unstructured document 110 is a binary image. That is, the box detection module 104 may convert the unstructured document 110 to a black and white image. In some examples, the binarization module 502 may be bypassed when the unstructured document 110 is already a binary image. Other preprocessing steps may also be taken by the binarization module 502. For example, the unstructured document 110 may undergo morphological operations (e.g., dilation, erosion, etc.) to remove noise and fill in any broken lines from the unstructured document 110.

At the CCA module 504, the unstructured image 110 may be divided into multiple regions or boxes. In an example, the CCA module 504 may detect various regions in the unstructured image 110. The regions may overlap such that smaller regions, such as individual cells, are located within larger regions, such as a table that includes the cells. In an example, the CCA module 504 may scan an image in a pixel-by-pixel manner to identify connected pixel regions. The connected pixel regions may include an indication that a set of pixels fall within the same box of the unstructured image 110. For example, the scan may identify adjacent pixels that include a common intensity value. In a binary image, an intensity value of a black pixel is ‘1’ and an intensity value of a white pixel is ‘0.’ After completing the scan, the pixels may be sorted into regions based on the connected pixels. The connected pixels may be indicated by, for example, groups of adjacent pixels with an intensity value of ‘1.’

At the box graph module 506, a box graph may be generated based on box locations, box-box overlapping (e.g., cell boxes within a larger table box), and relative distances between boxes. The box graph may be built on a series of nodes representing the unstructured document 110. In an example, the box graph module 504 may identify a root node (e.g., a whole page of the unstructured document 110), child nodes within the root node, grandchild nodes within the child nodes, and so on. Each node may include an indication of a text graph, an indication of child nodes, and an indication of neighboring nodes. Box neighboring relationships may be used to generate the tables 508 of the unstructured document 110. For example, adjoining boxes identified by the CCA module 504 may be labeled as being part of the same table 508.

FIG. 6 is an example of a box graph representation 600 of a document, according to certain aspects of the present disclosure. The box graph representation 600 may be generated from the unstructured document 110 using the box graph module 506. In an example, the box graph representation 600 is built based on box location, box-box overlapping, and relative distances between the boxes identified by the CCA module 504.

In the illustrated example, the box graph representation 600 includes a first layer 602, a second layer 604, a third layer 606, and an nth layer 608. Any number of layers may be included within the unstructured document 110 depending on the content of the unstructured document. The first layer 602 may include a root node 610 that may be the largest layer of the unstructured document 110. In an example, the root node 610 may represent a box that includes the entire unstructured document 110.

The second layer 604 may include a set of child nodes 612 that represent regions within the unstructured document 110. The regions may represent smaller sections of the unstructured document 110 than the whole page. The child nodes 612 may also include a neighbor indication 614. The neighbor indication 614 may indicate that a child node 612 is within a certain distance from another child node 612. Each of the child nodes 612 are located within the root node 610. That is, the child nodes 612 overlap with the root node 610.

The third layer 606 may include a set of grandchild nodes 616. The grandchild nodes 616 may represent smaller subsections or sub-regions of the unstructured document 110 than the sections or regions represented by the child nodes 612. The grandchild nodes 616 may also include a neighbor indication 614 indicating other grandchild nodes 616 within a specified distance. Each of the grandchild nodes 616 are located within a child node 612. That is, the grandchild nodes 616 overlap with both a child node 612 and the root node 610. An example of the grandchild node 616, child node 612, and root node 610 relationship may be a page, which is represented by the root node 610, that includes a table, which is represented by the child node 612, that includes individual cells, which are represented by one or more grandchild nodes 616.

The nesting of nodes in the box graph representation 600 may continue through the nth layer 608. The nth layer 608 of nodes may represent a final layer of boxes identified in the unstructured document by the CCA module 504. Each of the nodes 610, 612, and 616 within the box graph representation 600 may include a text graph, an indication of any child nodes associated with the nodes 610, 612, and 616, and an indication of any neighbor nodes associated with the nodes 610, 612, and 616. The indication of neighbor nodes for the individual nodes identified in the box graph representation 600 may be representative of the tables 508 output by the box detection module 104.

FIG. 7 is an example of detected boxes of the unstructured document 110 detected by the box detection module 104, according to certain aspects of the present disclosure. FIGS. 8 and 9 provide examples of portions of the detected boxes of the unstructured document 110, according to certain aspects of the present disclosure. As illustrated in FIG. 7, the unstructured document 110 includes a box 702, which includes the whole page of the unstructured document 110. Within the box 702 are a series of boxes that overlap with the box 702. For example, box 704 includes all of the text within the unstructured document 110, box 706 includes a subsection of the text within the box 704, and a table 708 represents a table within the box 704. Additional boxes are also shown in FIG. 7, but not specifically described.

Turning to FIG. 8, additional detail is provided for a portion of the unstructured document 110. As shown, each of the boxes 702, 704, and 706 include box information descriptions 802. The box information descriptions may identify a box identification, a table identification, and a level number of each box identified by the box detection module 104. For example, the box 702 has a box identification of 32, a table identification of 0, and a level number of 0. The table and level identifications of 0 may indicate that the box 702 is the root node of the unstructured document 110. The box 704 has a box identification of 31, a table identification of 1, and a level number of 1. Additionally, the box 706 has a box identification of 3, a table identification of 2, and a level identification of 2.

Each individual box within the unstructured document 110 may include a unique box identification number. Further, the boxes are grouped together with common table identification numbers. For example, boxes that form part of the same table include the same table identification number. Additionally, the level identification indicates whether the particular box is part of a root node, a child node, a grandchild node, etc., as indicated by the box graph representation 600 generated by the box graph module 506. For example, the level identification of 2 in box 706 indicates that box 706 is a child node of box 704 and a grandchild node of box 702.

FIG. 9 includes additional detail of the table 708 of the unstructured document 110 from FIG. 7. Each box within the table 708 is labeled with a table identification of 3 because the boxes are all part of the same table 708. Further, the boxes in the table 708 are labeled with a level identification of 2 indicating that the boxes are grandchild nodes of the block 702 in the unstructured document 110. The machine-encoded text from the optical character recognition module 102 may be integrated into the boxes described above with respect to FIGS. 7-9 based on box positions identified by the box detection module 104 that align with text vertices identified by the optical character recognition module 102.

FIG. 10 is an example of a text graph representation 1000 of information extracted from an unstructured document 110, according to certain aspects of the present disclosure. A root text node 1002 hosts all text within an individual box. Each child node 1004 and 1008 within the root node 1002 includes a text description, an indication of vertices associated with the text description, a confidence score, and an indication of neighbor text nodes. The text graph may be used to build a text block 1006a by linking the child nodes 1004 with neighboring child nodes 1004 that are within a specified distance. Similarly, the text graph may be used to build a text block 1006b by linking the child nodes 1008 with neighboring child nodes 1008 that are within a specified distance.

For example, the child nodes 1004 within the text block 1006a may be a set of child nodes 1004 all within the same table of the unstructured document 110. Likewise, the child nodes 1008 within the text block 1006b may be a set of child nodes 1008 all within the same table of the unstructured document 110. The child nodes 1004 of the text block 1006a that neighbor the child nodes 1008 of the text block 1006b may be separated in the unstructured document 110 by a sufficient distance to where the child nodes 1004 are not grouped with the child nodes 1008 within a text block. In such an example, a neighbor indication 1010 may indicate that the text blocks 1006a and 1006b are located physically close to one another in the unstructured document 110.

FIG. 11 is an example of a set of text blocks 1102, 1104, 1106, and 1108 each including text extracted from the unstructured document 110, according to certain aspects of the present disclosure. The text blocks 1102-1108 are built using the text graph representation 1000 of the information extracted from the unstructured document 110. The text blocks 1102-1108 may be portions of the text associated with one another. For example, the text block 1102 includes information associated with an “About Us” heading, the text block 1104 includes information associated with a “Services” heading, the text block 1106 includes information associated with an “Industry” heading, and the text block 1108 includes information associated with a “Contact” heading.

FIG. 12 is an example of a structured text representation 1200 of the unstructured document 110, according to certain aspects of the present disclosure. The structured text representation 1200 may include a combination of the text graph representation 1000 and the box graph representation 600 of the unstructured document 110. For example, the text graph representation 1000 may provide indications of text that is included within particular boxes of the box graph representation 600. Accordingly, the structured text representation 1200 includes indications of the text and an identification of the boxes of the unstructured document 110 in which the text resides.

For example, a structured text portion 1202 provides an indication that the text “Branch/District Cost Ctr. No.:” is located within a box that is defined by a box identification of 2, a level identification of 3, and a table identification of 8. Each box of the unstructured document 110 may be defined in a similar manner within the structured text representation 1200. In an example, the structured text representation 1200 may be filtered using a depth-first traversal, a breadth-first traversal, a specific table identification, a specific box identification, or a specific level number. Further, the structured text representation 1200 may be used to perform natural language processing tasks, such as the document type clustering 112, the document type classification 114, the entity extraction 116, and a question and answer process 118.

To further illustrate the natural language processing tasks, FIG. 13 is a flowchart of a process 1300 for performing an entity extraction process from a structured text representation 1200 of an unstructured document 110, according to certain aspects of the present disclosure. At block 1302, the process 1300 involves receiving a key from an operator. The key may be a term from a table within the unstructured document 110 that is used to identify a value. For example, a “Customer Name” may be the key input by the operator, and the process 1300 may attempt to locate a value associated with the customer name located within a table, such as the name of a company.

At block 1304, the process 1300 involves receiving information of the box that includes the key. In an example, the key search that locates the box that includes the key may be performed on the structured text representation 1200 of the unstructured document 110. The search may be performed using a regex pattern search, a fuzzy search, or using a deep neural network, such as a Deep Bidirectional Encoder Representations from Transformers (BERT) model. The information of the box that includes the key may include a box identification number, a table identification number, and a level number.

At block 1306, the process 1300 involves searching text within the box that includes the key. The text may be searched to determine if the value associated with the key is located within the same box as the key. For example, the key may be associated with a box title, such as a prompt to enter data into a particular box. In such an example, the completed box (e.g., with the data prompted by the box title entered) may include the value associated with the key.

At block 1308, the process 1300 involves making a determination as to whether the value is in the same box as the key. If the value is not in the same box as the key, at block 1310, the process 1300 involves searching text in neighbor boxes for the value associated with the key. The neighbor boxes may be identified in the structured text representation 1200 as the boxes above, below, to the left, and to the right of the box including the key. In an example, this search may continue to expand outward until the value is found.

Upon identifying the value in a neighbor box, at block 1312, the process 1300 involves outputting the value associated with the key. Similarly, if, at block 1308, the process 1300 determines that the value is in the same box as the key, the process 1300 proceeds directly to block 1312 where the value associated with the key is output.

While the process 1300 involves identifying a particular value associated with a key (e.g., the entity extraction 116), other natural language processing techniques may also use the structured text representation 1200. For example, the structured text representation 1200 may also be used for the document type clustering 112, the document type classification 114, and the question and answer processes 118.

FIG. 14 shows an example computing device 1400 suitable for implementing aspects of the techniques and technologies presented herein. The example computing device 1400 includes a processor 1410 which is in communication with a memory 1420 and other components of the computing device 1400 using one or more communications buses 1402. The processor 1410 is configured to execute processor-executable instructions stored in the memory 1420 to perform secure data protection and recovery according to different examples, such as part or all of the example processes 200 and 1300 or other processes described above with respect to FIGS. 1-13. In an example, the memory 1420 is a non-transitory computer-readable medium that is capable of storing the processor-executable instructions. The computing device 1400, in this example, also includes one or more user input devices 1470, such as a keyboard, mouse, touchscreen, microphone, etc., to accept user input. The computing device 1400 also includes a display 1460 to provide visual output to a user.

The computing device 1400 can also include or be connected to one or more storage devices 1430 that provides non-volatile storage for the computing device 1400. The storage devices 1430 can store an operating system 1450 utilized to control the operation of the computing device 1400. The storage devices 1430 can also store other system or application programs and data utilized by the computing device 1400, such as modules implementing the functionalities provided by the document extraction system 100 or any other functionalities described above with respect to FIGS. 1-13. The storage devices 1430 might also store other programs and data not specifically identified herein.

The computing device 1400 can include a communications interface 1440. In some examples, the communications interface 1440 may enable communications using one or more networks, including: a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate arrays (FPGAs) specifically, to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

In the following, further examples are described to facilitate the understanding of the subject matter of the present disclosure:

As used below, any reference to a series of examples is to be understood as a reference to each of those examples disjunctively (e.g., “Examples 1-4” is to be understood as “Examples 1, 2, 3, or 4”).

Example 1 is a computer-implemented method, comprising: accessing, by a processor, an unstructured document; performing, by the processor, box detection on the unstructured document to generate a box graph of the unstructured document; integrating, by the processor, identified text of the unstructured document with the box graph of the unstructured document to build a text graph; and generating, by the processor, a structured text representation of the unstructured document using the text graph.

Example 2 is the computer-implemented method of example 1, further comprising: receiving, by the processor, a key request; searching, by the processor, text within a first box that includes a key associated with the key request, text in a set of neighbor boxes to the first box, or both; and identifying, by the processor, a value associated with the key and identified in the first box or at least one box of the set of neighbor boxes.

Example 3 is the computer-implemented method of examples 1-2, wherein the identified text is integrated with the box graph using text vertices of the identified text and box positions within the box graph.

Example 4 is the computer-implemented method of examples 1-3, wherein the structured text representation comprises assignments of portions of the identified text to a box identification number, a level identification number, and a table identification number of the box graph.

Example 5 is the computer-implemented method of examples 1-4, further comprising: performing, by the processor, document type clustering, document type classification, entity extraction, or question and answer processes using the structured text representation of the unstructured document.

Example 6 is the computer-implemented method of examples 1-5, wherein generating the structured text representation of the unstructured document using the text graph comprises performing a depth-first traversal on the text graph, a breadth-first traversal on the text graph, a table identification search on the text graph, a box identification search on the text graph, or a level number search on the text graph.

Example 7 is the computer-implemented method of examples 1-6, further comprising: performing, by the processor, character recognition on text of the unstructured document to generate the identified text within the unstructured document.

Example 8 is the computer-implemented method of example 7, wherein the character recognition comprises optical character recognition, and wherein the identified text comprises a machine-encoded text representation comprising a text representation, text bounding boxes, and a text confidence indication.

Example 9 is a computing system, comprising: one or more processors; and one or more memory devices including instructions that are executable by the one or more processors for causing the one or more processors to: access an unstructured document; perform character recognition on text of the unstructured document to identify text within the unstructured document; perform box detection on the unstructured document to generate a box graph of the unstructured document; integrate the identified text of the unstructured document with the box graph of the unstructured document to build a text graph; and generate a structured text representation of the unstructured document using the text graph.

Example 10 is the computing system of example 9, wherein the character recognition performed on the text of the unstructured document comprises an optical character recognition that generates the identified text, wherein the identified text comprises a machine-encoded text representation of the unstructured document.

Example 11 is the computing system of examples 9-10, wherein the instructions are further executable by the one or more processors for causing the one or more processors to: receive a key request; search text within a first box that includes a key associated with the key request, text in a set of neighbor boxes to the first box, or both; and identifying a value associated with the key and identified in the first box or at least one box of the set of neighbor boxes.

Example 12 is the computing system of examples 9-11, wherein the identified text is integrated with the box graph using text vertices of the identified text and box positions within the box graph.

Example 13 is the computing system of examples 9-12, wherein the structured text representation comprises assignments of portions of the identified text to a box identification number, a level identification number, and a table identification number of the box graph.

Example 14 is the computing system of examples 9-13, wherein the instructions are further executable by the one or more processors for causing the one or more processors to: perform document type clustering, document type classification, entity extraction, or question and answer processes using the structured text representation of the unstructured document.

Example 15 is the computing system of examples 9-14, wherein generating the structured text representation of the unstructured document using the text graph comprises performing a depth-first traversal on the text graph, a bread-first traversal on the text graph, a table identification search on the text graph, a box identification search on the text graph, or a level number search on the text graph.

Example 16 is a non-transitory computer-readable medium comprising computer-executable instructions to cause a computer to: access, by a processor, an unstructured document; perform, by the processor, character recognition on text of the unstructured document to identify text within the unstructured document; perform, by the processor, box detection on the unstructured document to generate a box graph of the unstructured document; integrate, by the processor, the identified text of the unstructured document with the box graph of the unstructured document to build a text graph; and generate, by the processor, a structured text representation of the unstructured document using the text graph.

Example 17 is the non-transitory computer-readable medium of example 16, comprising further computer-executable instructions to cause the computer to: receive, by the processor, a key request; search, by the processor, text within a first box that includes a key associated with the key request, text in a set of neighbor boxes to the first box, or both; and identify, by the processor, a value associated with the key and identified in the first box or at least one of the set of neighbor boxes.

Example 18 is the non-transitory computer-readable medium of examples 16-17, wherein the identified text is integrated with the box graph using text vertices of the identified text and box positions within the box graph.

Example 19 is the non-transitory computer-readable medium of examples 16-18, comprising further computer-executable instructions to cause the computer to: perform, by the processor, document type clustering, document type classification, entity extraction, or question and answer processes using the structured text representation of the unstructured document.

Example 20 is the non-transitory computer-readable medium of example(s) 16, wherein performing the box detection on the unstructured document comprises performing a connected component analysis on the unstructured document.

Different arrangements of the components depicted in the drawings or described above, as well as components and steps not shown or described are possible. Similarly, some features and sub-combinations are useful and may be employed without reference to other features and sub-combinations. Embodiments of the presently subject matter have been described for illustrative and not restrictive purposes, and alternative embodiments will become apparent to readers of this patent. Accordingly, the present disclosure is not limited to the embodiments described above or depicted in the drawings, and various embodiments and modifications may be made without departing from the scope of the claims below.

1. A computer-implemented method, comprising:
accessing, by a processor, an unstructured document;
performing, by the processor, box detection on the unstructured document to generate a box graph of the unstructured document;
integrating, by the processor, identified text of the unstructured document with the box graph of the unstructured document to build a text graph; and
generating, by the processor, a structured text representation of the unstructured document using the text graph,
wherein the structured text representation comprises assignments of portions of the identified text to a box identification number, a level identification number, and a table identification number of the box graph.

2. The computer-implemented method of claim 1, further comprising:
receiving, by the processor, a key request;
searching, by the processor, text within a set of neighbor boxes to a first box, wherein the first box includes a key associated with the key request; and
identifying, by the processor, a value associated with the key and identified in at least one box of the set of neighbor boxes.

3. The computer-implemented method of claim 1, wherein the identified text is integrated with the box graph using text vertices of the identified text and box positions within the box graph.

4. (canceled)

5. The computer-implemented method of claim 1, further comprising:
performing, by the processor, document type clustering, document type classification, entity extraction, or question and answer processes using the structured text representation of the unstructured document.

6. The computer-implemented method of claim 1, wherein generating the structured text representation of the unstructured document using the text graph comprises performing a depth-first traversal on the text graph, a breadth-first traversal on the text graph, a table identification search on the text graph, a box identification search on the text graph, or a level number search on the text graph.

7. The computer-implemented method of claim 1, further comprising:
performing, by the processor, character recognition on text of the unstructured document to generate the identified text within the unstructured document.

8. The computer-implemented method of claim 7, wherein the character recognition comprises optical character recognition, and wherein the identified text comprises a machine-encoded text representation comprising a text representation, text bounding boxes, and a text confidence indication.

9. A computing system, comprising:
one or more processors; and
one or more memory devices including instructions that are executable by the one or more processors for causing the one or more processors to:
access an unstructured document;
perform character recognition on text of the unstructured document to identify text within the unstructured document;
perform box detection on the unstructured document to generate a box graph of the unstructured document;
integrate the identified text of the unstructured document with the box graph of the unstructured document to build a text graph; and
generate a structured text representation of the unstructured document using the text graph,
wherein the structured text representation comprises assignments of portions of the identified text to a box identification number, a level identification number, and a table identification number of the box graph.

10. The computing system of claim 9, wherein the character recognition performed on the text of the unstructured document comprises an optical character recognition that generates the identified text, wherein the identified text comprises a machine-encoded text representation of the unstructured document.

11. The computing system of claim 9, wherein the instructions are further executable by the one or more processors for causing the one or more processors to:
receive a key request;
search text within a set of neighbor boxes to a first box, wherein the first box includes a key associated with the key request; and
identify a value associated with the key and identified in at least one box of the set of neighbor boxes.

12. The computing system of claim 9, wherein the identified text is integrated with the box graph using text vertices of the identified text and box positions within the box graph.

13. (canceled)

14. The computing system of claim 9, wherein the instructions are further executable by the one or more processors for causing the one or more processors to:
perform document type clustering, document type classification, entity extraction, or question and answer processes using the structured text representation of the unstructured document.

15. The computing system of claim 9, wherein generating the structured text representation of the unstructured document using the text graph comprises performing a depth-first traversal on the text graph, a bread-first traversal on the text graph, a table identification search on the text graph, a box identification search on the text graph, or a level number search on the text graph.

16. A non-transitory computer-readable medium comprising computer-executable instructions to cause a computer to:
access, by a processor, an unstructured document;
perform, by the processor, character recognition on text of the unstructured document to identify text within the unstructured document;
perform, by the processor, box detection on the unstructured document to generate a box graph of the unstructured document;
integrate, by the processor, the identified text of the unstructured document with the box graph of the unstructured document to build a text graph; and
generate, by the processor, a structured text representation of the unstructured document using the text graph,
wherein the structured text representation comprises assignments of portions of the identified text to a box identification number, a level identification number, and a table identification number of the box graph.

17. The non-transitory computer-readable medium of claim 16, comprising further computer-executable instructions to cause the computer to:
receive, by the processor, a key request;
search, by the processor, text within a set of neighbor boxes to a first box, wherein the first box includes a key associated with the key request; and
identify, by the processor, a value associated with the key and identified in at least one of the set of neighbor boxes.

18. The non-transitory computer-readable medium of claim 16, wherein the identified text is integrated with the box graph using text vertices of the identified text and box positions within the box graph.

19. The non-transitory computer-readable medium of claim 16, comprising further computer-executable instructions to cause the computer to:
perform, by the processor, document type clustering, document type classification, entity extraction, or question and answer processes using the structured text representation of the unstructured document.

20. The non-transitory computer-readable medium of claim 16, wherein performing the box detection on the unstructured document comprises performing a connected component analysis on the unstructured document.

21. The computer-implemented method of claim 1, wherein the assignments indicate, for each of the portions of the identified text, a level identification number of the box graph, a table identification number of the box graph, and a box identification number of a box in which the text resides, and
wherein the structured text representation comprises:
an assignment of a first portion of the identified text to a first table identification number of the box graph, a first box identification number of the box graph, and a first level identification number of the box graph which indicates that a box identified by the box ID number is a child node of the unstructured document; and
an assignment of a second portion of the identified text to a second table identification number of the box graph, a second box identification number of the box graph, and a second level identification number of the box graph which indicates that a box identified by the box ID number is a grandchild node of the unstructured document.

22. The computer-implemented method of claim 21, wherein the structured text representation comprises an assignment of a third portion of the identified text to a third table identification number of the box graph, a third box identification number of the box graph, and the second level identification number of the box graph.
